(19) United States
(12) Patent Application Publication
(10) Pub. No.: US 2008/0192803 A1
(43) Pub. Date: Aug. 14, 2008

(54) Extreme Temperature Optical Sensor Designs And Signal Processing

(76) Inventors: Nabeel Agha Riza, Oviedo, FL (US); Frank Perez, Tujunga, CA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/923,151

(22) Filed: Oct. 24, 2007

Related U.S. Application Data
(60) Provisional application No. 60/862,709, filed on Oct. 24, 2006.

(51) Int. Cl. G01K 11/00

(52) U.S. Cl. 374/161

(57) ABSTRACT

Two new techniques to form extreme environment minimally invasive freespace targeted optical temperature sensors using preferably single crystal Silicon Carbide (SiC) optical sensor chips. One technique uses wavelength signal processing exploiting the SiC chip's quadratic nature of its Thermo-optic effect. The other sensing method uses spatial signal processing while utilizing the temperature dependent Snell's law effect. A unique multi-sensor temperature measurement system is described using optical switching, fiber-remoting, and wavelength controls.

### SPECIFIC DATA RELATED TO THE INVENTION

This application claims the benefit of U.S. provisional application, application Ser. No. 60/862,709 filed on Oct. 24, 2006.

This invention was made with United States Government support awarded by the following agencies: U.S. Department of Energy (DOE) Grant No.: DE-FC26-03NT41923. The United States has certain rights in this invention.

### FIELD OF INVENTION

There are numerous vital sensing scenarios in commercial and defense sectors where the environment is extremely hazardous. Specifically, the hazards can be for instance due to extreme temperatures, extreme pressures, highly corrosive chemical content (liquids, gases, particulates), nuclear radiation, biological agents, and high Gravitational (G) forces. Realizing a sensor for such hazardous environments remains to be a tremendous engineering challenge. One specific application is fossil fuel fired power plants where temperatures in combustors and turbines typically have temperatures and pressures exceeding 1000° C. and 50 Atmospheres (atm). Future clean design zero emission power systems are expected to operate at even high temperatures and pressures, e.g., >2000° C. and >400 atm [J. H. Ausubel, “Big Green Energy Machines,” The Industrial Physicist, AIP, pp. 20-24, October/November, 2004.] In addition, coal and gas fired power systems produce chemically hazardous environments with chemical constituents and mixtures containing for example carbon monoxide, carbon dioxide, nitrogen, oxygen, sulphur, sodium, and sulphuric acid. Over the years, engineers have worked very hard in developing electrical high temperature sensors (e.g., thermo-couples using platinum and rodium), but these have shown limited life-times due to the wear and tear and corrosion suffered in power plants [R. E. Bentley, “Thermocouple materials and their properties,” Chap. 2 in Theory and Practice of Thermoelectric Thermometry: Handbook of Temperature Measurement, Vol. 3, pp. 25-81, Springer-Verlag Singapore, 1998].

Researchers have turned to optics for providing a robust high temperature sensing solution in these hazardous environments. The focus of these researchers has been mainly directed in two themes. The first theme involves using the optical fiber as the light delivery and reception mechanism and the temperature sensing mechanism. Specifically, a Fiber Bragg Grating (FBG) present within the core of a single mode fiber (SMF) acts as a temperature sensor. A broadband light source is fed to the sensor and the spectral shift of the FBG reflected light is used to determine the temperature value. Today, commercial FBG sensors use Ultra-Violet (UV) exposure in silica fibers. Such FBG sensors are typically limited to under 600° C. because of the instability of the FBG structure at higher temperatures [B. Lee, “Review of the present status of optical fiber sensors,” Optical Fiber Technology, Vol. 9, pp. 57-79, 2003]. Recent studies using FBGs in silica fibers has shown promise up-to 1000° C. [M. Winz, K. Stump, T. K. Plant, “High temperature stable fiber Bragg gratings, “Optical Fiber Sensors (OFS) Conf. Digest, pp. 195 198, 2002; D. Grobnic, C. W. Smelser, S. J. Mihailov, R. B. Walker,” Isothermal behavior of fiber Bragg gratings made with ultrafast radiation at temperatures above 1000 C,” European Conf. Optical Communications (ECOC), Proc. Vol. 2, pp. 130-131, Stockholm, Sep. 7, 2004]. To practically reach the higher temperatures (e.g., 1600° C.) for fossil fuel applications, single crystal Sapphire fiber has been used for Fabry-Perot cavity and FBG formation [H. Xiao, W. Zhao, R. Lockhart, J. Wang, A. Wang, “Absolute Sapphire optical fiber sensor for high temperature applications,” SPIE Proc. Vol. 3201, pp. 36-42, 1998; D. Grobnic, S. J. Mihailov, C. W. Smelser, H. Ding, “Ultra high temperature FBG sensor made in Sapphire fiber using Isothermal using femtosecond laser radiation,” European Conf. Optical Communications (ECOC), Proc. Vol. 2, pp. 128-129, Stockholm, Sep. 7, 2004]. The single crystal Sapphire fiber FBG has a very large diameter (e.g., 150 microns) that introduces multi-mode light propagation noise that limits sensor performance. An alternate approach [see Y. Zhang, G. R. Pickrell, B. Qi, A. S.-Jazi, A. Wang, “Single-crystal sapphire-based optical high temperature sensor for harsh environments,” Opt. Eng., 43, 157-164, 2004] proposed replacing the Sapphire fiber frontend sensing element with a complex assembly of individual components that include a Sapphire bulk crystal that forms a temperature dependent birefringent Fabry-Perot cavity, a single crystal cubic zirconia light reflecting prism, a Glan-Thompson polarizer, a single crystal Sapphire assembly tube, a fiber collimation lens, a ceramic extension tube, and seven 200 micron diameter multimode optical fibers. Hence this proposed sensor frontend sensing element not only has low optical efficiency and high noise generation issues due to its multi-mode versus SMF design, the sensor frontend is limited by the lowest high temperature performance of a given component in the assembly and not just by the Sapphire crystal and zircomia high temperature ability. Add to these issues, the polarization and component alignment sensitivity of the entire frontend sensor assembly and the Fabry-Perot cavity spectral notch/peak shape spoiling due to varying cavity material parameters. In particular, the Sapphire Crystal is highly birefringent and hence polarization direction and optical alignment issues become critical.

An improved packaged design of this probe using many alignment tubes (e.g., tubes made of Sapphire, alumina, stainless steel) was shown in Z. Huang. G. R. Pickrell, J. Xu, Y. Wang, Y. Zhang,, A. Wang, “Sapphire temperature sensor coal gasifier field test,” SPIE. Proc. Vol. 5590, p. 27-36, 2004. Here the fiber collimator lens for light collimation and the bulk polarizer (used in Y. Zhang, G. R. Pickrell, B. Qi, A. S.-Jazi, A. Wang, “Single-crystal sapphire-based optical high temperature sensor for harsh environments,” Opt. Eng., 43, 157-164, 2004) are interfaced with a commercial Conax, Buffalo multi-fiber cable with seven fibers; one central fiber for light delivery and six fibers surrounding the central fiber for light detection. All fibers have 200 micron diameters and hence are multi-mode fibers (MMF). Hence this temperature sensor design is again limited by the spectral spoiling plus other key effects when using very broadband light with MMFs. Specifically, light exiting a MMF with the collimation lens has poor collimation as it travels a free-space path to strike the sensing crystal. In effect, a wide angular spread optical beam strikes the Sapphire crystal acting as a Fabry-Perot etalon. The fact that broadband light is used further multiplies the spatial beam spoiling effect at the sensing crystal site. This all leads to additional coupling problems for the receive light to be picked up by the six MMFs engaged with the single fixed collimation lens. Recall that the best Fabry-Perot effect is obtained when incident light is highly collimated; meaning it has high spatial coherence. Another problem plaguing this design is that any unwanted mechanical motion of any of the mechanics and optics along the relatively long (e.g., 1 m) freespace optical processing path from seven fiber-port to Sapphire crystal cannot be countered as all optics are fixed during operations. Hence, this probe can suffer catastrophic light targeting and receive coupling failure causing in-operation of the sensor. Although this design used two sets of manual adjustment mechanical screws each for 6-dimension motion control of the polarizer and collimator lens, this manual alignment is only temporary during the packaging stage and not during sensing operations. Another point to note is that the tube paths contain air undergoing extreme temperature gradients and pressure changes; in effect, air turbulence that can further spatially spoil the light beam that strikes the crystal and also for receive light processing. Thus, this mentioned design is not a robust sensor probe design when using freespace optics and fiber-optics.

Others such as Conax Buffalo Corp. U.S. Pat. No. 4,794,619, Dec. 27, 1988 have eliminated the freespace light path and replaced it with a MMF made of Sapphire that is later connected to a silica MMF. The large Numerical Aperture (NA) Sapphire fiber captures the Broadband optical energy from an emissive radiative hot source in close proximity to the Sapphire fiber tip. Here the detected optical energy is measured over two broad optical bands centered at two different wavelengths, e.g., 0.5 to 1 microns and 1 to 1.5 microns. Then the ratio of optical power over these two bands is used to calculate the temperature based on prior 2-band power ratio vs. temperature calibration data. This two wavelength band power ratio method was proposed earlier in M. Gottlieb, et. al., U.S. Pat. No. 4,362,057, Dec. 7, 1982. The main point is that this 2-wavelength power ratio is unique over a given temperature range. Using freespace optical infrared energy capture via a lens, a commercial product from Omega Model iR2 is available as a temperature sensor that uses this dual-band optical power ratio method to deduce the temperature. Others (e.g., Luna Innovations, VA and Y. Zhu, Z. Huang, M. Han, F. Shen, G. Pickrell, A. Wang, “Fiber-optic high temperature thermometer using sapphire fiber,” SPIE Proc. Vol. 5590, pp. 19-26, 2004.) have used the Sapphire MMF in contact with a high temperature handling optical crystal (e.g., Sapphire) to realize a temperature sensor, but again the limitations due to the use of the MMF are inherent to the design.

It has long been recognized that SiC is an excellent high temperature material for fabricating electronics, optics, and optoelectronics. For example, engineers have used SiC substrates to construct gas sensors [A. Arbab, A. Spetz and I. Lundstrom, “Gas sensors for high temperature operation based on metal oxide silicon carbide (MOSiC) devices,” Sensors and Actuators B, Vol. 15-16, pp. 19-23, 1993]. Prior works include using thin films of SiC grown on substrates such as Sapphire and Silicon to act as Fabry Perot Etalons to form high temperature fiber-optic sensors [G. Beheim, “Fibre-optic thermometer using semiconductor-etalon sensor,” Electronics Letters, vol. 22, p. 238, 239, Feb. 27, 1986; L. Cheng, A. J. Steckl, J. Scofield, “SiC thin film Fabry-Perot interferometer for fiber-optic temperature sensor,” IEEE Tran. Electron Devices, Vol. 50, No. 10, pp. 2159-2164, October 2003; L. Cheng, A. J. Steckl, J. Scofield, “Effect of trimethylsilane flow rate on the growth of SiC thin-films for fiber-optic temperature sensors,” Journal of Microelectromechanical Systems, Volume: 12, Issue: 6, Pages: 797-803, December 2003]. Although SiC thin films on high temperature substrates such as Sapphire can operate at high temperatures, the SiC and Sapphire interface have different material properties such as thermal coefficient of expansion and refractive indexes. In particular, high temperature gradients and fast temperature/pressure temporal effects can cause stress fields at the SiC thin film-Sapphire interface causing deterioration of optical properties (e.g., interface reflectivity) required to form a quality Fabry-Perot etalon needed for sensing based on SiC film refractive index change. Note that these previous works also had a limitation on the measured unambiguous sensing (e.g., temperature) range dictated only by the SiC thin film etalon design, i.e., film thickness and reflective interface refractive indices/reflectivities. Thus, making a thinner SiC film would provide smaller optical path length changes due to temperature and hence increase the unambiguous temperature range. But making a thinner SiC film makes the sensor less sensitive and more fragile to pressure. Hence, a dilemma exists. In addition, temperature change is preferably estimated based on tracking optical spectrum minima shifts using precision optical spectrum analysis optics, making precise temperature estimation a challenge dependent on the precision (wavelength resolution) of the optical spectrum analysis hardware. In addition, better temperature detection sensitivity is achieved using thicker films, but thicker etalon gives narrower spacing between adjacent spectral minima. Thicker films are harder to grow with uniform thicknesses and then one requires higher resolution for the optical spectrum analysis optics. Hence there exists a dilemma where a thick film is desired for better sensing resolution but it requires a better precision optical spectrum analyzer (OSA) and of course thicker thin film SiC etalons are harder to make optically flat. Finally, all to these issues the Fabry-Perot cavity spectral notch/peak shape spoiling due to varying cavity material parameters that in-turn leads to deterioration in sensing resolution.

Material scientists have also proposed non-contact laser assisted ways to sense the temperature of optical chips under fabrication. Here, both the chip refractive index change due to temperature and thermal expansion effect have been used to create the optical interference that has been monitored by the traditional Fabry-Perot etalon fringe counting method to deduce temperature. These methods are not effective to form a real-time temperature sensor as these prior-art methods require the knowledge of the initial temperature when fringe counting begins. For industrial power plant applications, such prior knowledge is not possible, while for laboratory material growth and characterization, this prior knowledge is possible. Prior works in this general laser-based materials characterization field include: F. C. Nix & D. MacNair, “An interferometric dilatometer with photographic recording,” AIP Rev. of Scientific Instruments (RSI) Journal, Vol. 12, February 1941; V. D. Hacman, “Optische Messung der substrat-temperatur in der Vakuumaufdampftechnik,” Optik, Vol. 28, p 115, 1968; R. Bond, S. Dzioba, H. Naguib, J. Vacuum Science & Tech., 18(2), March 1981; K. L. Saenger, J. Applied Physics, 63(8), April 15, 1988; V. Donnelly & J. McCaulley, J. Vacuum Science & Tech., A 8(1), January/February 1990; K. L. Saenger & J. Gupta, Applied Optics, 30(10), Apr. 1, 1991; K. L. Saenger, F. Tong, J. Logan, W. Holber, Rev. of Scientific Instruments (RSI) Journal, Vol. 63, No. 8, August 1992; V. Donnelly, J. Vacuum Science & Tech., A 11(5), September/October 1993; J. McCaulley, V. Donnelly, M. Vernon, I. Taha, AIP Physics Rev. B, Vol. 49, No. 11, 15 March 1994; M. Lang, G. Donohoe, S. Zaidi, S. Brueck, Optical Engg., Vol. 33, No. 10, October 1994; F. Xue, X. Yangang, C. Yuanjie, M. Xiufang, S. Yuanhua, SPIE Proc. Vol. 3558, p. 87, 1998.

### SUMMARY DESCRIPTION OF THE INVENTION

The key to the new approach lies in understanding the unique optical behavior of thick (e.g., >300 micron) single crystal SiC when subjected to extreme temperature changes. More specifically, we have been able (see FIG. 1) to deduce the Thermo-Optic Coefficient (TOC) dn/dT of 6H-SiC from room temperature to 1000° C. at the useful eye-safe 1550 nm wavelength. This data shows the TOC to show a quadratic index change behavior with temperature. Here n(T) for wavelength of 1550 nm is given by an interpolated quadratic expression as shown in FIG. 1. In effect, the refractive index of SiC is unique for a given T and wavelength and follows a quadratic slope (i.e., dn/dT) expression. This statement becomes key in implementing the proposed unambiguous temperature measurement signal processing for the proposed two sensor design methods.

### Sensor Design Method 1-Spectral Fringe Approach

Use a local spatial area of the SiC chip that has highly flat/parallel faces. For any given temperature, sweep the wavelength about a chosen design wavelength for which the TOC is known (e.g., 1550 nm) to determine the wavelength spacing between any two maxima (or minima) or one maxima and one minima. This inter-spectral fringe wavelength change will be unique for a given temperature of the preferred 6H single crystal SiC chip. Hence by simply measuring this wavelength change value, the sensor temperature is directly determined. Unlike the older phase-based processing method in our prior patent application N. A. Riza and F. Perez, “High Temperature Minimally Invasive Optical Sensing Modules,” filed on Jul. 20, 2005, application Ser. No. 11/185,540, there is no need for further processing. In fact, as there is no phase-based post processing, there is no assumption used for two beam interference and the classic Fabry Perot interference inherently leads to the spectral fringes. Hence, no approximation is made in the new proposed signal processing steps.

### Sensor Design Method 2-Spatial Fringe Approach

Use a SiC chip that acts like a very weak wedge. Then use a global spatial target area of the SiC chip and observe the reflected interferogram outside the chip at a chosen distance. Because the chip is a weak wedge, at room temperature one observes a given linear fringe pattern with a very low (e.g., 1 cycle over observation zone) spatial frequency. As the SiC chip temperature changes, the TOC comes into play and chip refractive index n changes. Because Snell's law of refraction is in effect at the chip target boundary, the n change causes a change in angle of the returning beam coming off-the-wedged face and through the first entrance SiC-air boundary. In effect, the observed fringe period will change. Thus by simply measuring the change in the observed spatial fringe period one can determine the chip temperature and hence sensor provided temperature. Here, a given fringe period is unique for a given temperature. Again, no further signal processing is required to get the unambiguous temperature value.

A unique multi-sensor temperature measurement system is described using optical switching, fiber-remoting, and wavelength controls.

### DESCRIPTION OF THE DRAWINGS

FIG. 1 is a graph of experimentally measured 6H-SiC Thermo-optic Coefficient (TOC) versus 6H-SiC chip temperature at 1550 nm. The TOC expression shows a quadratic dependence on the temperature. (From N. A. Riza, et. al., J. Applied Physics, 2005)

FIG. 2 illustrates an embodiment of a basic temperature sensor design using wavelength signal processing according to the present invention.

FIG. 3 is a graph of experimentally determined 6H SiC refractive index versus temperature behavior.

FIG. 4 is a graph of a temperature sensor calibration table example showing unique values of Δλ versus T for a chosen central test wavelength of 1550 nm and 6H single crystal SiC chip material.

FIG. 5 is an alternate embodiment of the a temperature sensor using the Snell law of refraction principle and a wedged SiC Chip and Spatial Signal Processing in one form of the present invention;

FIG. 6 is a graph showing temperature sensor calibration data produced by fringe period change with SiC chip temperature change using the embodiment of FIG. 5; and

FIG. 7 illustrates an embodiment of an N temperature probe design such as for advanced turbine combustor sections.

### DETAILED DESCRIPTION OF THE INVENTION

Temperature Sensor Design using Unambiguous Wavelength Signal Processing

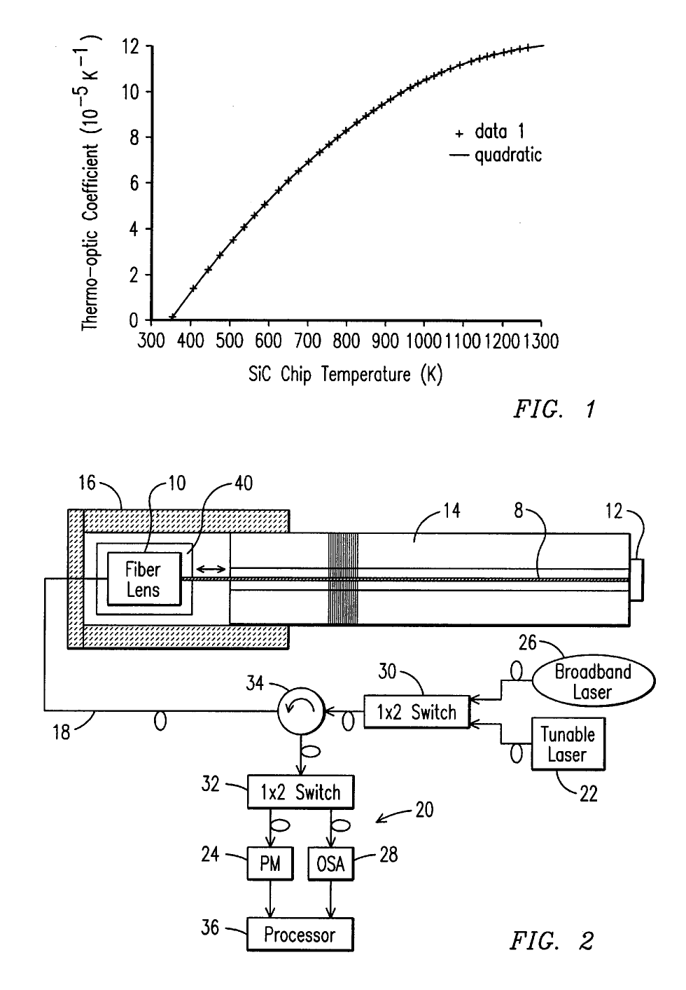

FIG. 2 shows a basic temperature sensor system design incorporating the teaching of the present invention. The design uses wavelength signal processing to deduce the SiC chip ambiguous temperature. An example packaging is disclosed in the patent application by N. A. Riza and F. Perez, “Optical Sensor For Extreme Environment”, application Ser. No. 11/567,600, filed Dec. 6, 2006. The key point to note is that an infrared collimated laser beam 8 sent from a controlled fiber 10 lens strikes the thick SiC chip 12 positioned in the hot zone at a distance from the lens. The SiC chip is attached to a preferably non-porous sintered SiC hollow tube 14 (with an inner and outer diameter) forming an optical coupler with a robust sealed end. The SiC chip reflected light passes through the SiC tube and low Coefficient of Thermal Conduction (CTC) ceramic tube 16 to be coupled back into the single mode fiber 18 through the lens 10 and sent to the remote system 20 for wavelength processing. The sensor system can operate in two modes. One uses a tunable laser 22 and power meter 24 to implement wavelength swept signal processing. Here today's fast tunable lasers and photo-meters can be deployed. The other method will use a moderately broadband (e.g., 3 nm) source 26 and an Optical Spectrum Analyzer (OSA) 28 to do parallel wavelength channels signal processing in processor 36. The two fiber-optic switches 30, 32 are used to select which laser/detection system is used. Depending on the temperature sensing scenario dynamics and the hardware specification, one or the other method may be better. The processor accesses the raw data with comparison to calibration data and computes the temperature. Next, the novel signal processing aspect of the proposed sensor is explained using our measured 6H-SiC single crystal optical characteristics. The circular 34 allows laser light to fiber 18 and reflected light to switch 32. Sampled light from switch 30 can also pass through circulator 34 to switch 32. The fiber lens 10 and fiber 18 end to which lens 10 is attached is mounted on an electronically controlled mount 40 that allows adjustment of the lens angle in tilt and translation to set focus of the beam 8 on chip 12.

The basic idea of our original optical wireless temperature sensor using single crystal SiC in a retro-reflective arrangement was described earlier in patent application N. A. Riza and F. Perez, “High Temperature Minimally Invasive Optical Sensing Modules,” for which a US non-provisional application for United States Patent was filed on Jul. 20, 2005, application Ser. No. 11/185,540. In this earlier application, the natural low Fresnel reflection coefficient (R=r²=[(n−1)/((n+1)]²=0.193) of SiC in air at the infrared band centered at 1550 nm leads to the thick SiC chip behaving as a poor Fabry-Perot etalon. This in-turn leads the SiC reflected optical power to be approximated well as a two beam interference written as:

Pₘ=K·R_{FP}˜K[R+(1−R)²R+2(1−R)R cos φ](1)

where R_{FP} is the instantaneous optical reflectivity of the basic frontend SiC Fabry-Perot element while K is a constant that depends upon the experimental conditions such as input power, power meter response gain curve, beam alignments, and losses due to other optics. Here the classic general Fabry-Perot power reflectance for the chip in air is given by:

$${R}_{FP} = \frac{2 R ( 1 + cos φ )}{1 + {R}^{2} + 2 R cos φ} . \qquad ( 2 )$$

In addition, optical noise in the system with time can also change the amount of light received for processing, thus varying the constant K. Here the optical path length (OPL) parameter in radians for the proposed sensor is defined as:

$$OPL = φ = \frac{4 π n ( λ ) d}{λ} , \qquad ( 3 )$$

where φ is the round-trip propagation phase in the SiC crystal of thickness d and refractive index n at a tunable laser wavelength λ at normal incidence. When the temperature T changes, n and d change causing an OPL change and hence a change in received power that produces many optical power cycles with temperature. Thus for any given optical power reading, there may be many temperature values possible, indicating ambiguous temperature readings from the sensor. To solve this ambiguous temperature problem, we earlier showed how two wavelength phase-shift based signal processing can be used to deduce the temperature value. This becomes the basis of our previous SiC temperature sensor where indirect signal processing leads to the temperature value. The purpose of the new design described here is a simpler direct signal processing sensor.

Using Eqn. 3, for a given temperature T, the difference in the defined Optical Path Length (OPL) for two different temperature probe wavelengths λ₁ and λ₂ can be made equal to 2π to produce any two consecutive maxima or minima in the reflected optical power spectrum of the SiC chip acting as a Fabry-Perot cavity. In effect, one can write:

$$\frac{4 π}{{λ}_{1}} {n}_{1} d - \frac{4 π}{{λ}_{2}} {n}_{2} d = 2 π \\ \frac{2}{{λ}_{1}} {n}_{1} d - \frac{2}{{λ}_{2}} {n}_{2} d - 1 \qquad ( 4 )$$

Let λ₂=λ₁+Δλ, then from Eq. 4 we can write:

$$\frac{2}{{λ}_{1}} {n}_{1} d - \frac{2}{{λ}_{1} + Δ λ} {n}_{2} d = 1 \\ \frac{2}{{λ}_{1}} {n}_{1} d - \frac{2}{{λ}_{1} ( 1 + \frac{Δ λ}{{λ}_{1}} )} {n}_{2} d = 1 \\ \frac{2 d}{{λ}_{1}} [ {n}_{1} - \frac{{n}_{2}}{( 1 + \frac{Δ λ}{{λ}_{1}} )} ] = 1 \qquad ( 5 )$$

Using the approximation given by:

$$\frac{1}{1 + x} \approx 1 - x , x << 1 \\ ∴ \frac{1}{( 1 + \frac{Δ λ}{{λ}_{1}} ) \approx 1 - \frac{Δ λ}{{λ}_{1}}}$$

Which is valid as Δλ<<λ, one can write Eq. 5 as:

$$\frac{2 d}{{λ}_{1}} [ {n}_{1} - {n}_{2} ( 1 - \frac{Δ λ}{{λ}_{1}} ) ] = 1 \\ \frac{2 d}{{λ}_{1}} [ {n}_{1} - {n}_{2} + {n}_{2} 1 - \frac{Δ λ}{{λ}_{1}} ] = 1 \\ \frac{2 d}{{λ}_{1}} [ - Δ n ( Δ λ ) + {n}_{2} \frac{Δ λ}{{λ}_{1}} ] = 1 \\ Δ n ( Δ λ ) = {n}_{2} - {n}_{1} \qquad ( 6 )$$

Recall that n₁ and n₂ are the refractive indices of 6H SiC for the λ₁ and λ₂, respectively. Here the temperature is unchanged at T and so these indices are computed by the Sellmeier equation. Using our recent experimentally obtained results for the TOC of 6H Single Crystal SiC measured at 1550 nm (see FIG. 1) given as:

$$\frac{\partial n}{\partial T} = - 1.2 \times {10}^{- 10} {T}^{2} + 3.2 \times {10}^{- 7} T - 9.7 \times {10}^{- 5}$$

One can write the refractive index as:

$$n ( T ) = \frac{- 1.2 \times {10}^{- 10} {T}^{3}}{3} + \frac{3.2 \times {10}^{- 7} {T}^{2}}{2} - 9.7 \times {10}^{- 5} T + D$$

Next, one can use the known Sellmeier equation for the wavelength dependent refractive index of 6H-SiC given for room temperature to determine the value of D in the SiC refractive index versus temperature expression. Hence we can write:

$$T = {T}_{i} , n = \sqrt{A + \frac{B {λ}^{2}}{{λ}^{2} - C}}$$

$$\sqrt{A + \frac{B {λ}^{2}}{{λ}^{2} - C}} = - 0.4 \times {10}^{- 10} {T}_{i}^{3} + 1.6 \times {10}^{- 7} {T}_{i}^{2} - 9.7 \times {10}^{- 5} {T}_{i} + D$$

$$D = \sqrt{A + \frac{B {λ}^{2}}{{λ}^{2} - C}} + 0.4 \times {10}^{- 10} {T}_{i}^{3} - 1.6 \times {10}^{- 7} {T}_{i}^{2} + 9.7 \times {10}^{- 5} T \\ ∴ n ( T ) = \sqrt{A + \frac{B {λ}^{2}}{{λ}^{2} - C}} - 0.4 \times {10}^{- 10} ( {T}^{3} - {T}_{i}^{3} ) + 1.6 \times {10}^{- 7} ( {T}^{2} - {T}_{i}^{2} ) - 9.7 \times {10}^{- 5} ( T - {T}_{i} )$$

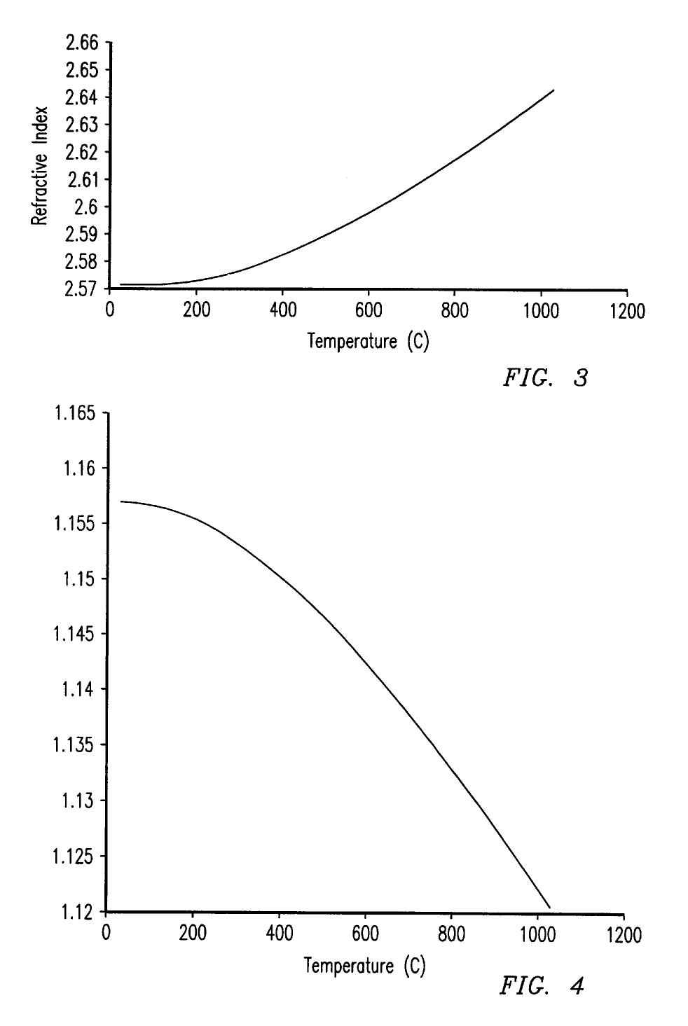

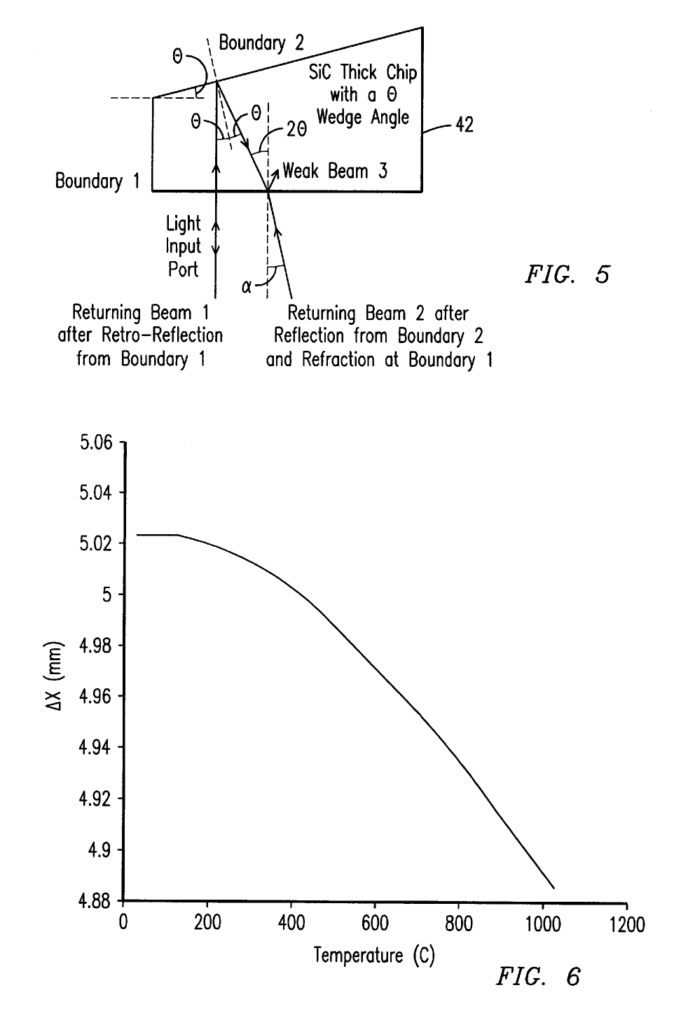

In the listed n(T) equation, one can now put the known values of A, B, C (from Sellmeier Eqn. parameters), λ (i.e., 1550 nm used to get the FIG. 6 data), and Ti as room temperature (298 K), one can plot (see FIG. 3) the refractive index n of 6H SiC versus temperature for the chosen test wavelength of 1550 nm. Now considering the Coefficient of Thermal Expansion (CTE) α′ of the chip via d(T)=[1+α′(T−Tᵢ)]d(Tᵢ) and putting all values in Eqn. (6) gives:

$$\frac{2 [ 1 + {α}^{′} ( T - {T}_{i} ) ] d ( {T}_{i} )}{{λ}_{1}} [ - ( \sqrt{A + \frac{{B ( {λ}_{1} + Δ λ )}^{2}}{{( {λ}_{1} + Δ λ )}^{2} - C}} - \sqrt{A + \frac{B {λ}_{1}^{2}}{{λ}_{1}^{2} - C}} ) + {n}_{2} \cdot \frac{Δ λ}{{λ}_{1}} ] = 1 \\ where \\ {n}_{2} = ( \sqrt{A + \frac{{B ( {λ}_{1} + Δ λ )}^{2}}{{( {λ}_{1} + Δ λ )}^{2} - C}} - 0.4 \times {10}^{- 10} ( {T}^{3} - {T}_{i}^{3} ) + 1.6 \times {10}^{- 7} ( {T}^{2} - {T}_{i}^{2} ) - 9.7 \times {10}^{- 5} ( T - {T}_{i} ) ) \qquad ( 7 )$$

Here, n₂ is found using the n(T) expression with λ=λ₂=λ₁+Δλ. Next using the known SiC values given by:

A=1,B=5.5515,C=0.026406×10⁻¹²

λᵢ=1550nm

Tᵢ=298K

d(Tᵢ)=400 μm

α′=4.56×10⁻⁶

one can solve Eqn. 7 to find the values of Δλ versus T for a chosen central test wavelength of 1550 nm. This specific curve vital to our unambiguous temperature sensor operations is shown in FIG. 4. Clearly one can see that there is a unique Δλ value for each temperature value of the SiC chip. More specifically, Δλ decreases as T increases. Hence, to measure temperature, one dithers the wavelength about 1550 nm to get at least one peak-to-peak or null-to-null spectral fringe cycle. By measuring this unique Δλ fringe period by the OSA or power meter and comparing to the calibration table of Δλ vs. T, one can measure the T. Hence, highly direct one-step signal processing produces T for the proposed sensor. For the SiC chip case shown, room temperature to 1000° C. produces a reduction in Δλ from ˜1.157 run to ˜1.120 nm. In effect, a 0.047 nM wavelength change happens over this near 1000° C. temperature change. Given that today's OSA can produce 0.001 nm resolutions, one can deduce 47 coarse temperature measurement bins for the outlined design temperature sensor. In effect, the average temperature resolution comes to be ˜21° C. In effect, the Δλ vs. T calibration data looks like a stair-case type function with 47 steps and stair step size of the design example of ˜21° C. and stairs levels decreasing in height as temperature increases.

A much higher resolution temperature assessment in any coarse bin can be deduced by the traditional Fabry-Perot-based temperature sensing via spectrum notch/peak motion tracking, although within only one free spectral range of the etalon, i.e., within one unambiguous spectral fringe cycle. For a typical design using the wavelength signal processing based sensor design in FIG. 2, a typical average coarse temperature resolution may be ˜20° C. (Note: In practice it is a bit larger for lower temperatures values; see increasing slope of FIG. 1 with higher T). In order to get a greatly improved temperature sensing resolution, one can measure the increase or decrease in wavelength of a given peak or null near a chosen reference wavelength location, e.g., 1550 nm. For example, let us say that at T=T1 and chosen wavelength λ1=1550 nm, the normalized power received by the Photo-Detector (PD) is a maximum, e.g., P˜1 (or a minimum). In this case, one simply compares the Δλ vs T calibration stair-case function curve at 1550 nm with the Normalized Power P vs. T calibration curve at 1550 nm. The P vs T curve is highly periodic (as it is a classic Fabry-Perot response) and so has many T locations of power maximum or P˜1. Nevertheless, by looking at the measured Δλ vs. T stair-case function, one can say which exact power peak (Note that one can also choose to track the notch in the spectrum if the notch shape is a clearer deep function) in the P vs T curve is the correct T value. This is the simple case, when a T happens to produce a peak (or null) at the chosen 1550 nm wavelength. In this case, if we look at the broadband spectrum around 1550 nm, the 1550 nm location has the expected power peak (or null). In the more general case, say P=0.7, things are not as direct. In this case by comparing the P vs. T and the Δλ vs. T stair-case calibration curves, one realizes there are two location of T that meet this P=0.7 condition. To decide which T is the correct T, one needs to look at the broadband (e.g., 3 nm wide to give a few optical power cycles) optical power spectrum. If the closest peak near 1550 nm is located at a wavelength greater than 1550 nm, i.e., the broadband spectrum peak (or notch) has moved to a higher wavelength, then it implies for 6H single crystal SiC that the temperature has increased. Hence in this case, one picks the T from the P vs. T curve at P=0.7 that is at the higher temperature. On the other hand, if the temperature had dropped, the optical spectrum shifts to the lower wavelengths and in this case the peak closest to the 1550 nm reference location shifts to a lower wavelength. Hence, of the two T's from the P vs. T curve for the example P=0.7 position, one picks the temperature T that is a lower value. Because power P can be measured accurately (even in nano-Watts) and calibration temperature can also be measured very accurately (e.g., 0.5° C.), one can determine the two ambiguous T's from the P vs. T calibration curve very accurately. To decide which T is correct, one requires deciphering the direction of spectral peak (or null) shift versus a reference spectral peak (null) wavelength (or peak/null temperature). This deciphering ability is controlled by the wavelength resolution of the OSA or tunable laser. For example, a 400 micron SiC chip might produce a +1.15 nm shift of the reference peak(or null) to the next consecutive peak (or null) when temperature increased by example 20° C. This 20° C. limit is dictated by the free spectral range of the SiC etalon; so if one used wavelength shift alone to determine temperature as is done in classical etalon-based temperature sensors, the sensor unambiguous temperature range would be limited to a very small 20° C. limit. Thus, designers try to use a thinner etalon to increase temperature unambiguous dynamic range but then lose resolution apart from making the etalon chip more fragile. In our case, we don't have this dilemma as the Δλ vs. T curve can keep the dynamic range very high (e.g., 2000° C.) while monitoring the chosen reference wavelength peak (or null) shift amount and shift direction within the much smaller temperature range (limited by the etalon free-spectral range) can keep the sensor temperature resolution very high. Thus both high resolution and high dynamic range can be achieved with our proposed signal processing. For example, if OSA resolution is 0.001 nm, a 1.15 nm maximum shift over 20° C. means one could measure temperature in this 20° C. zone with approximately 1.15/0.001=1150 bins or 20° C./1150˜0.02° C. Recall that power reading normalization is performed using the power maximum and minimum values for a given temperature T to get the P reading. This Power max/min value at any given temperature is obtained by dithering the tunable laser wavelength (as mentioned in our previous patent application filed on Jul. 20, 2005, application Ser. No. 11/185,540) or recording a small (e.g., 3 nm should give a few full optical power cycles on the OSA) broadband spectrum about the reference wavelength (e.g., 1550 nm). The choice of the reference wavelength used for tracking the spectrum shifts with temperature depends on the specific sensor design and application requirements and can be optimized to produce optimal temperature resolution for a given sensor temperature dynamic range.

Temperature Sensor Design using Spatial Signal Processing

FIG. 5 shows an alternate temperature sensor design. Here the SiC chip 42 has a small wedge angle θ making the chip with slightly non-parallel faces. This design exploits Snell's law of refraction. The incident light is normal to the chip entrance face (boundary 1) and so undergoes ˜19.5% Fresnel reflectance to produce a retroreflective beam 1. The remaining transmitted beam strikes the Boundary 2 at the wedge angle θ with Boundary 2 normal to produce a reflected beam also at an angle θ with the boundary 2 normal. Note that as the SiC refractive index “n” changes with temperature, θ does not change. This reflected beam now strikes the boundary 1 normal at a 2 θ incidence angle, next undergoing refraction at the SiC-air boundary to produce a refracted beam 2 at an α angle with boundary 1 normal. Applying Snell's law of refraction, n sin(2θ)=sin(α). Based on the Fresnel coefficients of SiC at 1550 nm, the beam 2 has about 12.5% of the incident power while beam 3 after another reflection at boundary 2 and refraction at boundary 1 has <0.5% of original incident beam power. Thus, one can consider the chip reflected and refracted beams to be two dominant beams that produce two beam interference in the observation field. In effect, to form the proposed temperature sensor, one observes the SiC chip produced interference pattern that is a sinusoidal fringe pattern with a spatial period Δx (assuming high collimation beams) given by:.

$$Δ x = \frac{λ}{sin α} = \frac{λ}{n sin 2 θ}$$

$$n ( T ) = \sqrt{A + \frac{B {λ}^{2}}{{λ}^{2} - C}} - 0.4 \times {10}^{- 10} ( {T}^{3} - {T}_{i}^{3} ) + 1.6 \times {10}^{- 7} ( {T}^{2} - {T}_{i}^{2} ) - 9.7 \times {10}^{- 5} ( T - {T}_{i} )$$

$$A = 1 , B = 5.5515 , C = 0.026406 \times {10}^{- 12}$$

$$λ = 1550 nm$$

$${T}_{i } = 298 K$$

$$θ = 0.003438 °$$

By using the known Sellmeier coefficents for 6H SiC and our measured SiC refractive index data with temperature change, FIG. 6 shows how the fringe period produced by the proposed sensor varies with temperature. In this example, it decreases by ˜140 microns when temperature increases from room temperature to 1000° C. It is clear that by measuring this change in fringe period, one can deduce the temperature of the SiC chip, hence forming the proposed temperature sensor using spatial signal processing. A variety of image and edge sensing devices and algorithms can be used to accurately deduce this fine fringe period change. One can also deploy image magnification optics (e.g., microscope, etc) to enlarge the edge images to produce a high temperature resolution sensor. Do note that the FIG. 6 principle temperature sensor can be packaged in various ways such as also previously described in N. A. Riza and F. Perez, “Extreme Temperature Optical Probe Designs,” provisional was filed and dated Dec. 5, 2005. The key point to note is no longer a tunable laser is required, so different low cost fixed λ wavelength visible lasers and image detectors can also be deployed to realize a low cost sensor. To capture the two received beams from the FIG. 5 sensor, even a fiber imaging bundle can be used in case fiber-remoting is preferred. Hence, appropriate optical transmit and receive optics needs to be designed around the basic front-end FIG. 5 sensor design to realize the packaged temperature probe using spatial signal processing.

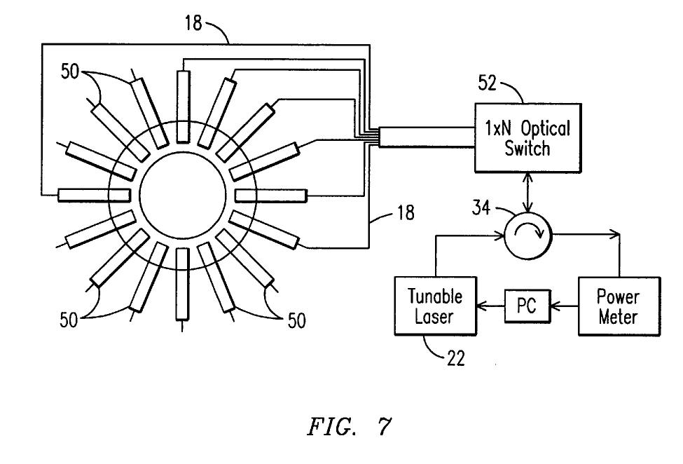

Today's advanced turbine design has many, e.g., N combustor baskets in the central hottest section of the combustion chamber where one would like to place N temperature probes. The temperatures in these combustor basket locations is predicted as over 1400° C., and today because of reliability and performance issues one cannot place any commercial temperature probes at these locations. With this key motivation in mind, a distributed sensor design is shown in FIG. 7 that uses common signal processing time multiplexed hardware with N independent SiC-based temperature probes 50 that have the fundamental properties to perform reliably in these combustion chamber settings. The different temperature probes are selected using the 1×N fiber-optic switch 52 and signal processing is implemented via wavelength signal processing as described in FIG. 2. The probes in this example use the FIG. 2 type temperature sensor designs. The circular operates as circulator 34 but only power meter 24 and laser source 22 are shown for this embodiment. The processor 36 is implemented as a personal computer using a database that defines the relationship of FIG. 1 as pairs of numbers in order to determine temperature. Alternatively, the processor could use the graph of FIG. 3 if the SiC 42 of FIG. 5 is used as the sensor.

1. An optically coupled temperature sensor comprising:
a silicon-carbide (SiC) crystal for positioning in a temperature measuring zone;
a high-temperature resistant optical coupler attached to the crystal and extending outward of the temperature measuring zone, the coupler comprising a sintered SiC tube;
a laser source for providing collimated light beam at a selected frequency into the optical coupler; and
a low heat transfer ceramic interface between said optical coupler and said laser source.

2. The sensor of claim 1 and including an optical fiber connecting said interface to said laser source, said fiber terminating in said interface.

3. The sensor of claim 2 and including a lens mounted to an end of said fiber in said interface.

4. The sensor of claim 3 and including a controllable mount supporting said fiber and lens in said interface, said mount being electronically adjustable in tilt and translation for focusing said collimated light onto said crystal.

5. The sensor of claim 4 wherein said laser source comprises a tunable laser source.

6. The sensor of claim 4 wherein said laser source comprises a broadband laser source.

7. A system comprising a plurality of the sensors of claim 4, each sensor arranged for monitoring a different temperature zone, and including an optical switch for selecting one of the sensors for temperature measurement.

8. The system of claim 7 wherein the sensor comprises an SiC crystal having one face non-parallel to an opposite face normal to the laser beam, the sensed temperature being a function of spatial fringe measurement.

9. A method for temperature measurement using a SiC crystal comprising:
inserting a SiC crystal into a zone where temperature is to be measured;
impinging a collimated laser beam at a selected frequency onto the crystal;
detecting a reflected laser beam from the crystal;
dithering the wavelength of the laser beam about the selected frequency to identify a spectral fringe cycle;
measuring the wavelength change to effect the cycle; and
extracting from a database a temperature of the crystal as a function of the wavelength change.
